(19) United States
(12) Patent Application Publication
(10) Pub. No.: US 2005/0196991 A1
(43) Pub. Date: Sep. 8, 2005

(54) Card immobilizing device

(75) Inventor: Heinz-Josef Hautvast, Brigachtal (NL)

Correspondence Address: SIEMENS SCHWEIZ;I-44, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 11/090,191

(22) Filed: Mar. 28, 2005

Related U.S. Application Data
(63) Continuation of application No. PCT/DE03/01724, filed on May 27, 2003.

(30) Foreign Application Priority Data
Oct. 4, 2002 (DE) 102 463 51.4

(51) Int. Cl. H01R 13/62

(52) U.S. Cl. 439/159

(57) ABSTRACT

The invention relates to a device for immobilising a card. The inventive device includes a slider which can move in insertion and ejection directions thereby transporting the card in the directions. The invention is includes at least one clamping unit which presses the card which is arranged in the slider against a bearing surface.

The invention relates to a card immobilizing device, having a slide, which can move in an insertion and ejection direction and transports the card in the insertion and ejection directions.

Card readers, in particular card readers for electronic smart cards, are used diversely. Thus, card readers for smart cards are used for example in the following areas.
1. In offices in conjunction with computers
2. In the medical field for the storage of patients' data
3. In banking for automatic teller machines, by way of example.

This enumeration in no way claims to be complete and is mentioned here only by way of example. What is common to the previous areas of use is that the installation locations and/or locations of use of the card readers are at a fixed location. This means that mechanical loading during operation of the card reader on the card can be virtually precluded.

If no mechanical loading occurs on the card, then disturbances during operation that are based on mechanical loading can likewise be precluded. Mechanical loading of smart cards may be for example:
1. Vibrations
2. Temperature fluctuations
3. Premature removal of the card

The risk of such loading is extremely low in the abovementioned locations of use and areas of use. However, the smart card is also suitable as an external storage medium for areas of use in which, by way of example, there is an obligation for logging predetermined data. An example that may be mentioned here is the area of commercial vehicles and the attendant obligation for the vehicle driver always to log his activities and the driving of the vehicle.

Card readers according to the prior art which have already penetrated the areas mentioned above cannot be used in automotive areas, particularly in the area of commercial vehicles, since they have no device whatsoever for immobilizing the card in the reader.

In the automotive area, however, mechanical loading occurs on the cards and thus also on the card readers. Said mechanical loading leads to disturbances during operation of the card reader with the card inserted. Vibrations lead to momentary interruptions of the contacts at the contact points, and great temperature fluctuations lead to warpage of the cards. This in turn also leads to permanent contact problems at the contact points of the electronic card.

The object of the invention is to provide a device which minimizes the risk of faults during operation of the reader with the smart card inserted due to the mechanical loading mentioned above.

This object is achieved according to the invention by virtue of the fact that at least one clamping body presses the card against a supporting area.

The card is thereby immobilized on the slide with sufficient force. This force suffices to eliminate vibrations and warpage of the card. The braking effect that is thus likewise achieved affords protection against premature removal of the card. When the card is inserted, it is pushed onto the slide, in which case, after the end position has been reached with respect to the slide, the clamping body immobilizes the card on the slide. As a consequence, the slide nevertheless remains moveable and introduces the card further into the reader. Since the card is connected to the slide by way of the clamping body or is immobilized thereon, further-reaching mechanisms for guiding the card into the reader are also possible. Moving the slide up and down with the card is mentioned by way of example.

In order that the card is preferably pressed against the supporting areas with predetermined force by means of the clamping body, the clamping body is prestressed by springs. It is also possible to use other means that are able to exert force on the clamping body and thus on the card. In one advantageous embodiment, the clamping body is designed in an elongate cylindrical form, the position of the clamping body being chosen in such a way that the card is pushed under the clamping body during insertion and said clamping body lies above the card parallel to the transverse axis of the card.

In order to exert higher forces on the card, in an advantageous development of the invention, a clamping body is arranged on the slide in such a way that the clamping body is fitted parallel to the transverse axis of the card, limbs that take up the clamping body being arranged on the sides of the slide. Said limbs form an acute angle toward the ejection direction with the plane of the card and also with the plane of the slide, which both run parallel to one another. The abovementioned clamping body is arranged in the region below the limb and above the card. A spring that is connected to the clamping body and is anchored to a frame-fixed location always pulls the clamping body in the direction of the acute angle. What is achieved by virtue of the cylindrical form of the clamping body and the pulling direction in the direction of the outlet direction or in the direction of the acute angle is, on the one hand, that when the card is inserted, the clamping body exerts no or only little force on the card, so that the latter can be inserted into the slide without any problems. On the other hand, a device configured in this way, when the card is pulled in the ejection direction, has the effect that said card, by means of the then increasing braking effect as a result of the clamping body wedging in the acute angle, that the card is secured to a greater extent as the tensile force rises in the ejection direction.

In order to realize the release of the card from the slide, a frame-fixed slot is preferably provided, which has a likewise frame-fixed stop on its sides. Said frame-fixed stop is configured in such a way that when the slide moves in the ejection direction, the clamping body is moved onto the stop and is thus moved out of the acute angle counter to the spring force. The card can then be removed from the slide and thus from the card reader.

The card is immobilized with respect to the slide in the inserted state. For this purpose, the slide has the supporting area against which the clamping body presses the card. The form and size of the supporting area are not crucial for the concept of the invention. What is crucial, however, is that the clamping body applies its force to the card with respect to said supporting area. It is also possible for a plurality of supporting areas to be arranged parallel to the axis of the clamping body. It is advantageous to arrange the supporting areas on the slide in such a way that the force is applied to the card as uniformly as possible or is distributed on the card along the axis of the clamping body.

The card is introduced with the slide into a frame-fixed card slot. For this purpose, the card slot expediently has a pyramidal shaping and thus prevents the card from getting stuck while it is being introduced into the slot. Once the end position has been reached, the card rests with the slide in the card slot. For this reason, it is advantageous to configure the supporting areas in such a way that they project beyond the slot bottom of the card slot. This prevents braking effects from occurring between card and card slot during introduction into the slot. For this reason, it is advantageous to provide the slot bottom with cutouts configured in such a way that they are able to take up the supporting area or the supporting areas over the entire length of the movement for the insertion and ejection directions.

In an advantageous development of the invention, the latter has locking bars on an outlet side, which locking bars, during operation, lock card and slide in the rest position in the reader and thus prevent inadvertent removal of the card. Said locking bars are opened when a card change is necessary or when a card is removed. Card and slide are thus freely moveable in the outlet direction. The slide has at least one lug at its end in the insertion direction, said lug serving as a stop for the card. This is advantageous in particular in order, on the one hand, as a result of the insertion movement of the card, to introduce the slide with the latter into the reader and, on the other hand, as a result of the ejection movement of the slide, to move the card with the latter out of the slot. In order to enable a movement of this type with respect to the card slot, recesses are advantageously arranged in the card slot, which recesses are able to take up the perpendicular lugs of the slide end or the card stop at the slide end over the entire length of the movement.

The material from which the device is produced is of secondary importance to the function of the device according to the invention. The material must be able to take up the forces that occur without being damaged. It is appropriate to use plastics or else metals or else metal plates.

The device is suitable for many areas of use of card readers. It is not solely restricted to areas of use which entail mechanical loading on the card. It is also suitable for use in quiet and mechanically nonloaded areas. However, as a result of the immobilization of the card in the reader as is realized by means of the device is particularly suitable for tacographs that enable the data to be recorded digitally on smart cards.

The invention is explained in more detail below on the basis of an exemplary embodiment illustrated in the figures, in which

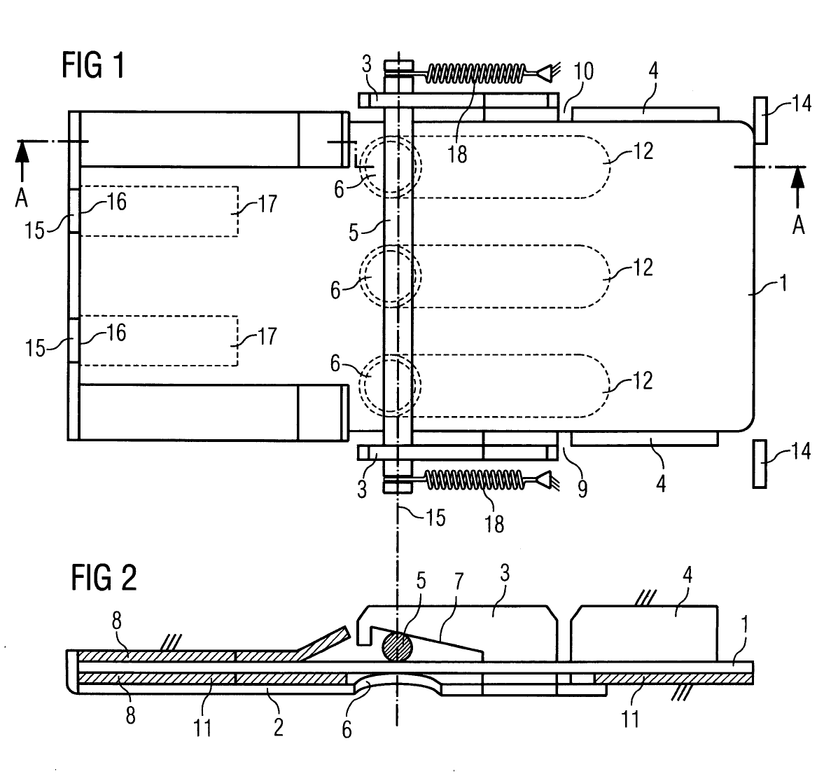

FIG. 1 shows a card immobilizing device in a view from above,

FIG. 2 shows the section A-A from FIG. 1.

The figures show an exemplary embodiment of a device for immobilizing a card 1 with a clamping body 5 designed as a cylindrical body. In this exemplary embodiment, the axis 13 of the clamping body 5 runs parallel to the transverse axis of the card 1. The clamping body 5 interacts with a slide 2 having a clamping device 3 in each case at its lateral ends 9 and 10, the cutout 7 of said clamping device forming an acute angle with the plane of the card 1 in the outlet direction.

The clamping body 5 is pulled by the force of springs 18 into the acute angle formed by the cutout 7 and the card 1. The card 1 is taken up in a card slot 8 with a slot bottom 11, the card slot 8 being expanded pyramidally at its slot start. Arranged on both sides of the card slot 8 is a frame-fixed stop 4 running perpendicular to the card bottom. The slot bottom 11 has cutouts 12 through which the supporting areas 6 reach, the cutouts 12 being configured in such a way that the supporting areas 6 can move therein over their entire direction of movement of the slide. The slide 2 has lugs 15 at its end, said lugs serving as card stop 16. For guiding the lugs 15, the slot bottom 11 has recesses 17 which are dimensioned in such a way that the lugs 15 can be moved therein in the entire direction of movement of the slide 2. In the outlet direction, the device has locking bars 14 for locking the card 1 in the reader.

The figures show the card 1 in the inserted operating position of the card 1 in the card immobilizing device. The slide 2 can move with respect to the frame-fixed card slot 8 and the frame-fixed stop 4 in the outlet direction. The position illustrated immobilizes the card between the clamping body 5 and the supporting area 6 by virtue of the fact that the clamping body 5 is pulled into the acute angle with a predetermined spring force of the springs 18 and a predetermined force is thus exerted on the card 1 by means of the cutout 7. In addition, the card is guided in the card slot 8.

Premature and unauthorized removal of the card 1 is thus prevented by the clamping effect of the clamping body 5 that intensifies in the outlet direction.

In the event of a permitted card removal, the entire slide 2 with card 1, clamping device 3 and clamping body 5 and also the supporting areas 6 moves toward the outlet direction until the clamping body 5 strikes the frame-fixed stop 4, and the force between clamping body 5 and supporting area 6 thus decreases and the card can be removed.

While the slide 2 is being moved in the outlet direction, the lugs 15 and the supporting areas 6 move in the respectively corresponding cutouts 12 and recesses 17 of the slot bottom 11. In this case, the supporting areas 6 are at least designed such that the surface of the supporting areas 6 projects above the surface of the slot bottom 11, thus avoiding a braking effect with respect to the slot bottom 11 and the card 1. The locking bars 14 constitute an additional safeguard against undesired or unauthorized card removal during card operation. The locking bars 14 are opened in the event of a permitted card removal. In order to illustrate the function of the locking bars 14, one of the locking bars is illustrated in the open position and the other locking bar in the closed position.

If the card 1 is to be introduced into the card immobilizing device, then the slide 2 is situated near the card outlet. The card is inserted into the slide and presses the clamping body 5 upward in the process, so that the card is situated between clamping body 5 and supporting area 6. While the card is being inserted as far as the card stop 16, the clamping body 5 does not bring about any clamping effect with respect to the card. Moreover, the clamping body still bears against the frame-fixed stop 4 at this point in time. It is only after the card 1 strikes the card stop 16 that the entire slide 2 is moved away from the frame-fixed stop and the card is thus completely introduced into the card slot 8. When the slide 2 moves away from the frame-fixed stop 4, the spring force of the spring 17 acts on the clamping body 5, which in turn presses the card 1 against the supporting area 6.

Once the card has been completely inserted, the locking bars 14 additionally prevent a premature or unauthorized card removal.

1. A device for immobilizing a card having a slide, which can move in insertion and ejection directions and transports the card in the insertion and ejection directions, characterized in that at least one clamping body presses the card against a supporting area and the supporting area being arranged in the slide, wherein the supporting area reaches through a slot bottom of the card slot and projects above it the slot bottom having a cutout in the region of the supporting area and the supporting area being able to be moved over therein over the entire length of the insertion and ejection movement of the slide.

2. The device according to claim 1, wherein the clamping body is arranged so as to be pressed against at least one supporting area by means of spring force.

3. The device according to claim 1, wherein the clamping body is a cylindrical body, the axis of which runs parallel to the plane of the slide and perpendicular to the insertion and ejection directions.

4. The device according to claim 1, further comprising a clamping device arranged on outer sides of the slide, the clamping device having a cutout that forms an acute angle with a plane of the slide in the ejection direction.

5. The device according to claim 1 wherein at least one frame-fixed card slot with a frame-fixed stop.

6. The device according to claim 1, wherein the clamping body is arranged so as to be movable toward the frame-fixed stop in the outlet direction with the slide for the purpose of releasing the card.

7. The device according to claim 1, wherein at least one supporting area is arranged in the slide, and the supporting area reaches through a slot bottom of the card slot and projects above it, the slot bottom having a cutout in the region of the supporting area and the supporting area being moveable over an entire length of the insertion and ejection movement of the slide.

8. The device according to claim 1 wherein at least one locking bar is arranged to block the card against premature removal in the ejection direction.

9. The device according to claim 11 wherein the slide has at least one lug that protrudes perpendicularly from the slot bottom and forms a card stop.

10. The device according to claim 1, wherein the slot bottom has at least one recess, the lug arranged so as to be movable over an entire length of the insertion and ejection movement of the slide.

11. The device according to claim 1, wherein the device comprises metal.

12. The device according to claim 1, wherein the device comprises plastic.

13. The device according to claim 1, wherein the card is an electronic smart card.

14. The device according to claim 1, wherein the device is a card readers for a tacographs.
